(19) United States
(12) Patent Application Publication
(10) Pub. No.: US 2006/0138261 A1
(43) Pub. Date: Jun. 29, 2006

(54) Heat dissipation device for a paper shredder

(76) Inventor: Kuan-Hua Ho, Hsin Chuang City (TW)

Correspondence Address: PRO-TECTOR INTERNATIONAL SERVICES, 20775 NORADA CT., SARATOGA, CA, 95070, US

(21) Appl. No.: 11/021,816

(22) Filed: Dec. 23, 2004

(51) Int. Cl. B02C 19/00

(52) U.S. Cl. 241/100

(57) ABSTRACT

The present invention is a paper shredder with an enhanced heat dissipation device, having a fan mounted on at one end of a motor inside a casing of the paper shredder. The fan will be running at the same time that the motor starts or operates to a specific temperature, thereby facilitating the heat dissipation of the motor, providing for long term operation of the paper shredder, and improving the operating efficiency of the paper shredder.

### BACKGROUND OF THE INVENTION

a) Field of the Invention

The present invention relates to a heat dissipation device for a paper shredder, and more particularly to a heat dissipation device comprising a fan fixed at one end of a motor inside a paper shredder, such that at the same time that the motor starts or when the motor reaches a specified temperature, the fan will be running to facilitate the heat dissipation of the motor, and providing for long term operation of the paper shredder, without increasing the size of the paper shredder.

b) Description of the Prior Art

A conventional fan of a paper shredder is located below a motor, and is a separate device from the motor. This approach of installing the fan cannot reduce the overall size of the paper shredder, and the fan is running at the same time that the motor is running, therefore the paper shredder will not be able to operate for a long time, without first shutting down the paper shredder and waiting for the paper shredder to cool down.

### SUMMARY OF THE INVENTION

The primary object of the present invention is to install a fan at one end of a motor inside a paper shredder, such that at the same time that the motor starts or when the motor reaches a specified temperature, the fan will be rotating, thereby facilitating the heat dissipation of the motor, providing for long term operation of the paper shredder, and improving operating efficiency, without increasing the size of the paper shredder.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a top view of the present invention.

FIG. 2 shows a side view of a fan and a motor of the present invention.

### DETAILED DESCRIPTION OF THE PREFERRED EMBODIMENTS

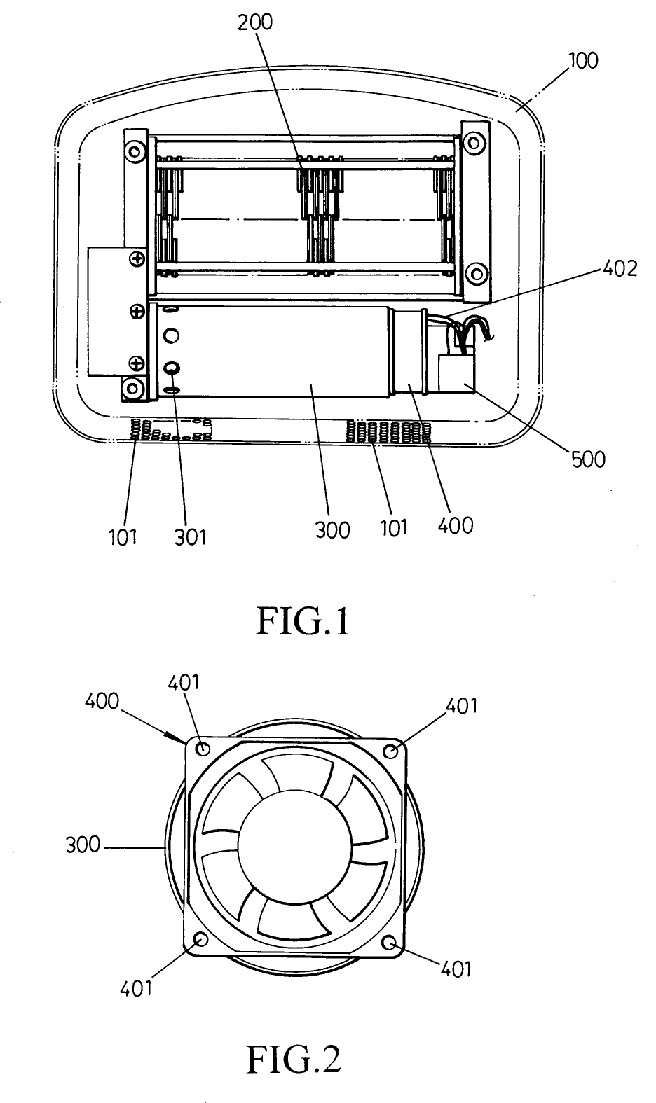

Referring to FIG. 1 and FIG. 2, shredding knives 200 and a motor 300 are installed inside a casing 100 of a shredder, wherein a high speed fan 400 is fixed at one end of the motor 300, using four bolts 401 to lock four corners of the fan 400 onto one end of the motor 300. The fan 400 is connected with a plate 500 via an electric wire 402, and can be rotating at the same time that the motor 300 starts, or operates for a certain amount of time and reaches a specified temperature, in order to facilitate the heat dissipation of the motor 300, and provide for long term operation of the paper shredder.

Referring to FIG. 1, a plurality of venting holes 301 are located at the other end of the motor 300, along with a plurality of venting holes 101 at proper locations on the casing 100. The aforementioned venting holes 301, 101 can also facilitate the heat dissipation of the paper shredder.

Accordingly, the present invention comprises a high speed fan located at one end of a motor; which will be running at the same time that the motor starts or when the motor operates to a specified temperature, thereby facilitating the heat dissipation of the motor.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A paper shredder with a heat dissipation device comprising:
a paper shredder outer casing adapted for shredding knives on a first side and a shredding knives drive motor on a second side opposite the first side, and having a plurality of venting holes on the paper shredder outer casing arranged in two groups, one group near each end of the drive motor side;
a plurality of paper shredding knives mounted with a horizontal axis inside the first side of the paper shredder outer casing;
a drive motor for the plurality of paper shredding knives, disposed inside the second side of the paper shredder outer casing, having
a drive end and an second end,
a drive motor casing,
an axis parallel to and offset along side of horizontal axis of the plurality of paper shredding knives; and
a fan mounted to the second end of the drive motor, and having
an electrical drive, and
a drive shaft that is parallel to the plurality of paper shredding knives and separate from the drive motor;
whereby the heat dissipation of the drive motor is facilitated.

2. A paper shredder with an augmented heat dissipation device according to claim 1, wherein the fan has four corners, and is mounted to the one end of the drive motor by a bolt near each of the four corners.
